(19) United States
(12) Patent Application Publication
(10) Pub. No.: US 2004/0025752 A1
(43) Pub. Date: Feb. 12, 2004

(54) Water-based cement including boiler ash as chemically active ingredient

(76) Inventor: Toshifumi Sugama, Upton, NY (US)

Correspondence Address: DICKSTEIN SHAPIRO MORIN & OSHINSKY LLP, 2101 L STREET NW, WASHINGTON, DC, 20037-1526, US

(21) Appl. No.: 10/603,991

(22) Filed: Jun. 26, 2003

Related U.S. Application Data
(60) Provisional application No. 60/391,585, filed on Jun. 27, 2002.

(51) Int. Cl. C04B 7/32

(52) U.S. Cl. 106/692; 106/694; 106/696; 106/706; 106/708

(57) ABSTRACT

A chemically-bonded cement material and concrete which includes a calcium aluminate component, a calcium silicate component, a sodium phosphate compound, and bottom ash which chemically reacts with the sodium phosphate compound to produce calcium phosphates. The chemically bonded cement may include a polymeric compound, such as acrylic-styrene copolymer, and fibrous materials, such as E-glass fibers, carbon fibers, or polypropylene. The concrete includes the chemically-bonded cement and aggregates. The materials are well suited as rapid setting repair patching and fill for damaged roads, remediating material for contaminated soil and as backfill underlayment, and as high strength precast concrete products.

### CROSS-REFERENCE TO RELATED APPLICATIONS

This application claims priority to U.S. provisional application serial No. 60/391,585, filed Jun. 27, 2002, the subject matter of which is incorporated herewith in its entirety.

### GOVERNMENT LICENSE RIGHTS

This invention was made with United States Government support under BNL Work for Others Subcontract No. NF-01-03, Prime Contract No. DE-AC02-98CH10886 awarded by the Department of Energy. The United States Government has certain rights in this invention.

### FIELD OF THE INVENTION

The invention generally relates to water-based cements, and more particularly to water-based cements that include boiler ash as a chemically active ingredient.

### BACKGROUND

Water-based cement is generally formed from a powder of alumina, silica, lime, iron oxide, and magnesium oxide. These powders are burned together in a kiln and finely pulverized. The pulverized powders are used as an ingredient of mortar and concrete. It is known to provide mineral aggregates to the cement to form concrete. Numerous mineral aggregates have been used, including silica, fly ash and boiler ash to name a few. While boiler ash is known to have been combined with cement, the combination has been chemically inert, i.e., the boiler ash has not generally been added to chemically alter the cement but instead has been added merely as an aggregate.

Coal-fired power stations burn coal to generate energy that can be converted to electricity. The byproducts of the burned coal include fly ash (light-weight solid particles of ash, dust and soot carried away from the burning coal by a draft), and bottom ash (a heavier, dark gray, granular, porous material generally collected in a water-filled hopper at the bottom of the furnace). The cost of disposal of such byproducts is significant and is further increased when the coal byproducts contain heavy metals, as is generally the case for boiler ash. By developing useful products that include these byproducts, the cost of disposal and concurrently the amount of pollution generated by the power plant is reduced.

There is thus a need for the development of useful products including boiler ash, also referred to as bottom ash, and other coal byproducts.

### SUMMARY

The invention provides a cement mixture that includes calcium aluminate component, optionally a calcium silicate component, a sodium phosphate compound, and boiler ash which chemically reacts with the sodium phosphate compound. The sodium phosphate compound is preferably polybasic sodium phosphate [NaP, —(NaPO₃—)—ₐ], although other suitable sodium phosphates and derivatives may be used, including, for example, sodium monohydrogen phosphates, sodium dihydrogen phosphates, and tribasic sodium phosphates.

The invention also provides a concrete that includes both active ingredients and inactive aggregates. The active ingredients include calcium aluminate cement, calcium silicate cement, a sodium phosphate compound, and boiler ash. Instead of calcium aluminate cement, a granulated blast furnace slag cement may be used, and instead of calcium silicate cement, fly ash may be used. The inactive aggregates include coarse aggregates and sand aggregates.

The invention also provides a lightweight concrete that includes active ingredients having calcium aluminate cement, calcium silicate cement, a sodium phosphate compound, and boiler ash, and inactive aggregates, including ceramic microspheres.

The invention also provides an all weather road capping material including a chemically-bonded cement material, a chemically inert aggregate material, and water. The chemically-bonded cement material includes calcium aluminate cement, calcium silicate cement, a sodium phosphate compound, and boiler ash which chemically reacts with the sodium phosphate compound. The chemically inert aggregate material includes coarse aggregates and sand aggregates.

The invention further provides soil remediation and cementitious backfill materials that have a chemically-bonded cement material, including calcium aluminate cement, optionally a calcium silicate cement, a sodium phosphate compound, and boiler ash which chemically reacts with the sodium phosphate compound, optionally a polymeric compound capable of inhibiting leaching out of heavy metals from the chemically-bonded cement material in use, soil, and water.

The invention further provides a method of forming a road capping material. The method includes the steps of providing a chemically-bonded cement material that includes calcium aluminate cement, calcium silicate cement, a sodium phosphate compound, and boiler ash which chemically reacts with the sodium phosphate compound, providing coarse aggregates and sand aggregates, providing water, and mixing the chemically-bonded cement material, the coarse aggregates, the sand aggregates and the water.

These and other advantages and features of the invention will be more readily understood from the following detailed description of the invention that is provided in connection with the accompanying drawings.

### BRIEF DESCRIPTION OF THE DRAWINGS

FIG. 1 is a graph of the sieve size of crushed boiler ash powders used in an embodiment of the invention.

FIG. 2 is a graph comparing the compressive strengths of a known cement material and a chemically bonded cement material of the present invention at various temperatures.

FIG. 3 is a graph showing changes in compressive strength at a specific temperature for twenty-four hour cured concrete formed from various concentrations of chemically bonded cements of the present invention.

FIG. 4 is a graph showing changes in compressive strength at a specific temperature for twenty-four hour cured concrete formed with various ratios of acrylic-styrene copolymer and chemically bonded cements of the present invention.

FIG. 5 is a graph showing a comparison of bending strengths of a chemically bonded cement of the present invention with various fibrous materials included.

FIG. 6 is a graph showing a comparison of tensile strengths of a chemically bonded cement of the present invention with various fibrous materials included.

FIG. 7 is a graph showing a comparison of weight loss due to freezing-thawing cycles between conventional portland cement concrete and concrete formed with a chemically bonded cement of the present invention.

FIG. 8 is a graph showing a comparison of shrinkage over time between conventional portland cement concrete and concrete formed with a chemically bonded cement of the present invention.

FIG. 9 is a graph showing changes over time in compressive strength of NaCl-contaminated cementitious backfill specimens having a thirty to seventy ratio of chemically-bonded cement to soil.

FIG. 10 is a graph showing a changes over time in compressive strength of backfill underlayments with various ratios of chemically-bonded cement and soil.

FIG. 11 is a graph showing changes over time in compressive strength of chemically-bonded cement of the present invention.

### DETAILED DESCRIPTION OF PREFERRED EMBODIMENTS

Now will be described a water-based cement material including boiler ash as a chemically active ingredient. The elemental composition of a boiler ash that may be utilized in the invention is provided in Table 1 below.

TABLE 1

| Element | Amount | Analysis Method |
|---|---|---|
| Arsenic | 178 mg/KG dry wt. | EPA 206.2 |
| Barium | 721 mg/KG dry wt. | EPA 208.1 |
| Cadmium | <0.20 mg/KG dry wt. | EPA 213.1 |
| Calcium | 42,900 mg/KG dry wt. | SW 846; 6010B |
| Chromium | 22.5 mg/KG dry wt. | EPA 218.2 |
| Copper | 1,610 mg/KG dry wt. | EPA 220.1 |
| Iron | 12,000 mg/KG dry wt. | EPA 236.1 |
| Lead | 264 mg/KG dry wt. | EPA 239.1 |
| Magnesium | 35,700 mg/KG dry wt. | SW 846; 6010B |
| Manganese | 336 mg/KG dry wt. | EPA 243.1 |
| Mercury | <0.25 mg/KG dry wt. | SW 846; 7471A |
| Nickel | 11,600 mg/KG dry wt. | EPA 249.1 |
| Selenium | 12 mg/KG dry wt. | EPA 270.2 |
| Vanadium | 86,700 mg/KG dry wt. | EPA 286.1 |

It should be appreciated, however, that any suitable elemental composition of boiler ash may be used to formulate the cement of the present invention. A preferred boiler ash is one which is relatively high in calcium, such as that shown in Table 1.

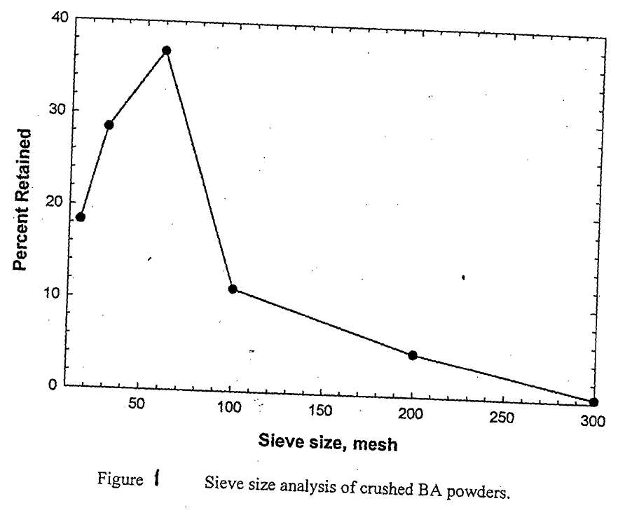

Briefly, and as will be described in greater detail below, concretes and other products of the present invention are formed from a boiler ash-based, chemically-bonded cement. The boiler ash received from a utility power plant is generally a rock-like bulky solid. A crusher, such as a Retruch Type BBlA portable crusher, manufactured by Brinkmann Company, may be used to pulverize the boiler ash. FIG. 1 shows a distribution of particle size for a typical pulverized boiler ash. A granular polybasic sodium polyphosphate [NaP, —(NaPO₃—)—ₐ], such as that manufactured by the Aldrich Chemical Company and known as an intermediate fertilizer may be used as an acid reactant. The calcium in the boiler ash reacts chemically with the sodium phosphate to create calcium phosphate, a major ingredient in cement. An inorganic additive, such as Secar # 51 calcium aluminate cement, manufactured by Lafarge Aluminates Ltd., may be added. Another inorganic additive, Type I calcium silicate cement, manufactured by Lehigh Portland Cement Corporation, also may be added. We have found that these additives improve mechanical strength and accelerate the acid-base reaction of the CBCs of the invention.

A fibrous material may also be included to improve toughness and ductility of the concrete. Suitable fibrous materials include:

(a) chopped E-glass, for example, those having dimensions of about eight microns in diameter by about six millimeters in length as supplied by Owens Corning Fiberglass;

(b) collaterally fibrillated polypropylene of, for example, about 18.8 millimeters in length as supplied by the Forta Corporation; and,

(c) chopped carbon fiber, for example fiber having dimensions of about 7.4 microns in diameter by about three millimeters in length and derived from a polyacrylonitrile precursor, as supplied by Asbury Graphite Mills, Inc.

An acrylic-styrene copolymer (ASC), for example, a water-born ASC emulsion as supplied by the BF Goodrich Corporation, may be included to sequester the high concentration of vanadium and the other heavy metals resident within the boiler ash. The ASC preferably has a pH of about 4.0, total polymeric solids of about fifty weight percent, and a viscosity of about 125 centipoise, although any suitable ASC composition may be utilized. We have found that ASC may be omitted and still achieve heavy metal sequestening by selecting bottom ash having a grain size distribution wherein about 65% of the material is smaller than about 75 mm. When this grain size is used, the cement preferably contains about 55% bottom ash, 40% calcium aluminate, and 5% sodium phosphate compound.

Finally, silica-based coarse aggregate sized between about, for example, 2.4 and 9.5 millimeters in diameter, and a silica sand aggregate sized between about, for example, 0.15 and 1.2 millimeters in diameter may be added to finalize the formulation of the concrete.

Extensive testing was performed on boiler ash-based chemically-bonded cement (CBC) and composites of the present invention to determine formulations for concretes useful as a road capping material under all weather conditions and over a temperature range of from 0° to 40° C.

Testing first was directed at formulating the boiler ash-based CBC such that it displayed a compressive strength of at least 1000 pounds per square inch (psi) after curing for only twenty-four hours over a temperature range of 0° to 40° C. Five formulations were prepared. The same amount of boiler ash, water and sodium phosphate was added to each of the five specimens, the only variables being the amount of calcium aluminate cement and the amount of Type I calcium silicate cement. Table 2 below provides the five formulations:

TABLE 2

| | Formulation, wt. % | | | | |
|---|---|---|---|---|---|
| | | Calcium | | | |
| Specimen | Boiler | aluminate | Type I calcium | Sodium | |
| No. | ash | cement | silicate cement | phosphate | Water |
| 1 | 42.6 | 27.8 | 0.0 | 7.0 | 22.6 |
| 2 | 42.6 | 22.2 | 5.6 | 7.0 | 22.6 |
| 3 | 42.6 | 16.7 | 11.1 | 7.0 | 22.6 |
| 4 | 42.6 | 11.1 | 16.7 | 7.0 | 22.6 |
| 5 | 42.6 | 5.6 | 22.2 | 7.0 | 22.6 |

The addition of water to each of the specimens creates a slurry. The CBC slurries were then cast in cylindrical molds and left for twenty-four hours. Four samples of each formulation were prepared and left to cure at, respectively, 0°, 10°, 25°, and 40° C. Table 3 below provides the compressive strengths of the specimens ascertained after a cure of twenty-four hours.

TABLE 3

| | Compressive Strength, psi | | | |
|---|---|---|---|---|
| Specimen No. | 0° | 10° | 25° | 40° |
| 1 | 1680 | * | * | * |
| 2 | 1520 | 2330 | 2680 | 2910 |
| 3 | 1470 | 2300 | 2480 | 2400 |
| 4 | 1300 | 2000 | 2150 | 2080 |
| 5 | 950 | 1850 | 1790 | 1800 |

The results of the tests shown in Table 3 indicate that two factors are responsible for strengthening specimens. One factor is the proportion of calcium aluminate cement (CAC) to Type I calcium silicate cement (CSC). Increasing the ratio of CAC to CSC improves a specimen's strength. Another factor is the atmospheric temperature. The strength of the specimens generally rises with an increase in the curing temperature. The specimen no. 1 cured at 0° C. had a higher compressive strength (1680 psi) than the other specimens cured at 0° C.; however, specimen no. 1 set too quickly to be placed in a mold, and so no data could be obtained, for the higher curing temperatures.

Based upon the results of the tests shown in Table 3, a preferred formulation of the boiler ash-based CBC is specimen no. 2, which includes about 42.6 weight percent of boiler ash, about 22.2 weight percent of CAC, about 5.6 weight percent of CSC, about 7.0 weight percent of sodium phosphate, and about 22.6 weight percent of water. This formulation provided excellent setting time and strength.

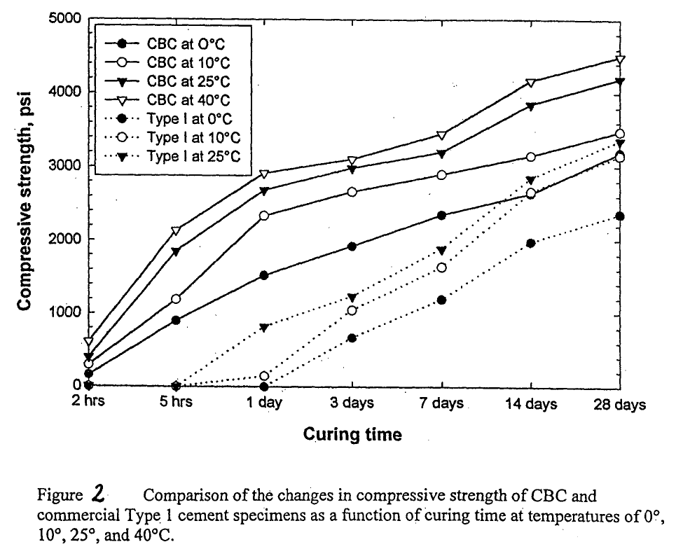

Further testing was performed on specimen no. 2 to ascertain the maximum strength of the specimen with a prolonged curing time at the temperature range of 0° C. to 40° C. FIG. 2 displays the results of curing specimen no. 2 at a temperature range of 0° C. to 40° C. for up to twenty-eight days and compares the compressive strength exhibited by specimen no. 2 against commercially known Type I CSC cement specimens. The specimen no. 2 cured at 0° C. developed an initial strength of about 200 psi two hours after mixing. After twenty-eight days of cure, that specimen exhibited a compressive strength of greater than 3000 psi. The specimen no. 2 cured at 40° C. had an initial strength of about 700 psi (three and a half times greater than that of the specimen no. 2 cured at 0° C.), which steadily increased to greater than 4400 psi. Both the specimens exhibited a compressive strength of greater than 4000 psi after curing for twenty-eight days.

The compressive strengths of the specimens no. 2 cured at the temperature range of 0° C. to 40° C. are compared in FIG. 2 to the compressive strengths over time of Type I CSC specimens cured at 0°, 25°, and 40° C. No appreciable compressive strength could be ascertained after five hours of cure time for the Type I CSC specimens. After twenty-eight days of cure, the specimen no. 2 cured at 0° C. had a compressive strength about 800 psi greater than that of the Type I CSC specimen cured at 0° C. The compressive strength of the specimen no. 2 cured at 10° C. was about 200 psi greater than that of the Type I CSC specimen cured at 10° C., and the compressive strength of the specimen no. 2 cured at 25° C. was about 900 psi greater than that of the Type I CSC specimen cured at 25° C.

Based upon the above-noted tests, a preferred formulation of a chemically-bonded cement mixture (prior to the addition of water) for use as a rapid-setting all season cement material is one having about fifty-five weight percent boiler ash, about twenty-nine weight percent calcium aluminate cement, about seven weight percent Type I calcium silicate cement, and about nine weight percent sodium phosphate.

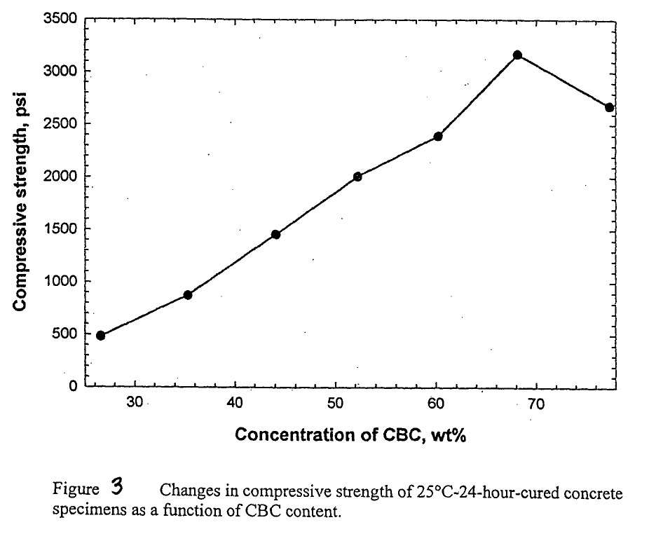

The next stage of testing was directed at developing concrete specimens that would have a compressive strength of greater than 3000 psi after allowing cure at room temperature for twenty-four hours. Concrete may be formed from cement plus a mineral aggregate. Two objectives of this stage of testing were to ascertain (a) appropriate proportions of boiler ash cement for a concrete system that also includes silica-based coarse aggregates (CA) and silica sand aggregates (SA) and (b) appropriate CA/SA ratios. Table 4 below and FIG. 3 provide the compressive strengths of concrete specimens as a function of the amount of aggregate used in the specimens.

TABLE 4

| Specimen | | | | Water, | Compressive |
|---|---|---|---|---|---|
| No. | CBC, wt. % | CA, wt. % | SA, wt. % | wt. % | strength, psi |
| 6 | 26.6 | 31.0 | 31.0 | 11.4 | 481 |
| 7 | 35.3 | 26.6 | 26.6 | 11.5 | 875 |
| 8 | 44.1 | 22.1 | 22.1 | 11.7 | 1458 |
| 9 | 52.3 | 17.4 | 17.4 | 12.9 | 2010 |
| 10 | 60.2 | 12.9 | 12.9 | 14.0 | 2394 |
| 11 | 68.1 | 8.5 | 8.5 | 14.9 | 3172 |
| 12 | 77.4 | 0.0 | 0.0 | 22.6 | 2780 |

As noted above, coarse aggregates (CA) are aggregates typically sized between about 2.4 and 9.5 millimeters, while sand aggregates (SA) are aggregates typically sized between about 0.15 and 1.2 millimeters. By providing equal amounts of CA and SA for each specimen, the changes in the compressive strengths of the specimens depend largely on the amount of chemically-bonded cement. As shown in FIG. 3 and outlined in Table 4, the specimen no. 11 exhibited the greatest compressive strength, with 68.1 weight percent of chemically-bonded cement, at 3172 psi. This compressive strength is greater than that of specimen no. 12 (having no CA or SA ratio) and of specimen no. 10 (having a CBC to CA/SA ratio of 60/40). The preferred ratio of cement to aggregate is about 80:20, the ratio of specimen no. 11.

Testing also was performed to determine the change in compressive strength by varying the CA/SA ratio. Tables 5-7 below outline compressive strengths for specimens having varying CA/SA ratios for specific weight percentages of the CBC. Specifically, Tables 5-7 provide the compressive strengths for specimens having CA/SA ratios of 60:40 (specimens nos. 13, 17, 21), 40:60 (specimens nos. 14, 18, 22), 30:70 (specimens nos. 15, 19, 23), and 10:90 (specimens nos. 16, 20, 24). Table 5 provides the compressive strengths for specimens 13-16 with a CBC weight percent of 52.3 and a CBC to CA/SA ratio of 60:40. Table 6 provides the compressive strengths for specimens 17-20 with a CBC weight percent of 60.2 and a CBC to CA/SA ratio of 70:30. Table 7 provides the compressive strengths for specimens 21-24 with a CBC weight percent of 68.1 and a CBC to CA/SA ratio of 80:20.

TABLE 5

| Specimen | | | | Water, | Compressive |
|---|---|---|---|---|---|
| No. | CBC, wt. % | CA, wt. % | SA, wt. % | wt. % | strength, psi |
| 13 | 52.3 | 20.9 | 13.9 | 12.9 | 2000 |
| 14 | 52.3 | 13.9 | 20.9 | 12.9 | 2018 |
| 15 | 52.3 | 10.5 | 24.3 | 12.9 | 1868 |
| 16 | 52.3 | 3.5 | 31.3 | 12.9 | 1779 |

TABLE 6

| Specimen | | | | Water, | Compressive |
|---|---|---|---|---|---|
| No. | CBC, wt. % | CA, wt. % | SA, wt. % | wt. % | strength, psi |
| 17 | 60.2 | 15.5 | 10.3 | 14.0 | 2319 |
| 18 | 60.2 | 10.3 | 15.5 | 14.0 | 2442 |
| 19 | 60.2 | 7.7 | 18.1 | 14.0 | 2021 |
| 20 | 60.2 | 2.6 | 23.2 | 14.0 | 1834 |

TABLE 7

| Specimen | | | | Water, | Compressive |
|---|---|---|---|---|---|
| No. | CBC, wt. % | CA, wt. % | SA, wt. % | wt. % | strength, psi |
| 21 | 68.1 | 10.2 | 6.8 | 14.9 | 2980 |
| 22 | 68.1 | 6.8 | 10.2 | 14.9 | 3200 |
| 23 | 68.1 | 5.1 | 11.9 | 14.9 | 2820 |
| 24 | 68.1 | 1.7 | 15.3 | 14.9 | 2613 |

Specimens having a ratio of CA to SA of 40:60 displayed the greatest compressive strength. Further, the specimens with a CBC to CA/SA ratio of 80:20 exhibited higher compressive strengths, with specimen no. 22 displaying the highest compressive strength at 3200 psi. From these results, another preferred formulation includes 68.1 weight percent of boiler ash CBC, 6.8 weight percent CA, 10.2 weight percent SA, and 14.9 weight percent water. Concrete formed from this formulation is particularly useful as a capping CBC concrete in road patch material systems.

As noted in Table 1, the boiler ash used in the formulation of the CBC according to the invention can include heavy metals, especially vanadium. Thus, any cement using such boiler ash is preferably formulated to reduce or inhibit the leaching out of one or more heavy metals into surrounding areas. While there is no Environmental Protection Agency (EPA) regulation controlling the permissible leaching of vanadium, a current EPA safe standard for lead indicates permissible leaching of less than five milligrams/liter.

A water-borne, organic polymer may be added to the CBC to sequester and inhibit leaching of vanadium and other heavy metals. A preferred polymeric additive is acrylic-styrene copolymer (ASC). ACS adheres well to both metals and cements. Tests were run to determine vanadium leachability of a CBC without ASC, and with ratios of five, ten and fifteen percent of ASC to CBC. The ASC was mixed in with the dry CBC and then water was added to attain a desirable consistency determined as zero slump. The CBC slurries were then cast into molds and left for two weeks at room temperature. The leaching of vanadium ions was measured in accordance with the Toxicity Characteristics Leaching Procedure recommended by the EPA. Table 8 below provides the results of the tests.

TABLE 8

| Specimen | CBC, | Water, | ASC, | ASC/CBC | Leachability, |
|---|---|---|---|---|---|
| no. | wt. % | wt. % | wt. % | ratio, % | mg/l |
| 25 | 77.4 | 22.6 | 0 | 0 | 271.0 |
| 26 | 72.0 | 24.4 | 3.6 | 5 | 4.3 |
| 27 | 67.4 | 25.9 | 6.7 | 10 | 6.2 |
| 28 | 63.2 | 27.3 | 9.5 | 15 | 3.1 |

While the CBC without any ASC liberated 271 mg/l of vanadium, the CBC specimens including ASC all liberated much smaller amounts of vanadium, all around the five mg/l standard. The amount of vanadium present in specimens nos. 25-28 is estimated to have been 1350 mg/kg, and thus hardened CBC including small amounts of ASC exhibits great ability to immobilize and sequester vanadium metal.

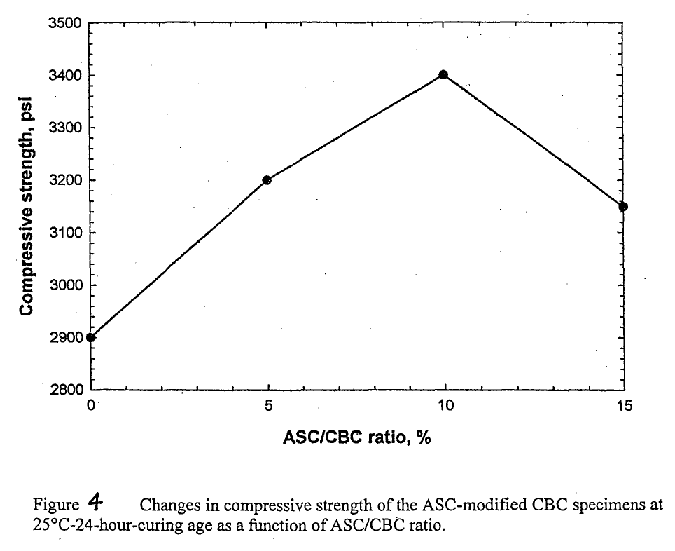

Table 9 provides formulations for four specimens, ranging from the absence of ASC to a fifteen percent ASC/CBC ratio, that were cured for twenty-four hours at 25° C. FIG. 4 plots the compressive strengths of the four specimens.

TABLE 9

| Specimen | CBC, | CA, | SA, | Water, | ASC solution, | ASC/CBC |
|---|---|---|---|---|---|---|
| No. | wt. % | wt. % | wt. % | wt. % | wt. % | ratio, % |
| 29 | 68.1 | 6.8 | 10.2 | 14.9 | 0.0 | 0 |
| 30 | 66.4 | 6.6 | 10.0 | 13.7 | 3.3 | 5 |
| 31 | 64.9 | 6.5 | 9.7 | 12.4 | 6.5 | 10 |
| 32 | 63.5 | 6.4 | 9.5 | 11.1 | 9.5 | 15 |

Specimen no. 31 exhibited the highest compressive strength at about 3400 psi, thus indicating that compressive strength of ASC/CBC concrete increases up to an ASC/CBC ratio of ten percent and then begins to decline. Thus, incorporating ten percent ASC to CBC in concrete both alleviates environmental impact from leaching heavy metals and also improves compressive strength.

Equation 1 below provides a chemical reaction that explains two important factors for the generation of the high compressive strength. One factor is the formation of well-crystallized hydroxyapatite [HOAp, Ca₅(PO₄)₃(OH)] and sodium vanadium sulfate hydrate [SVSH, (Na₂V(SO₄)₂.4H₂)]. The other factor is the development of a densified microstructure.

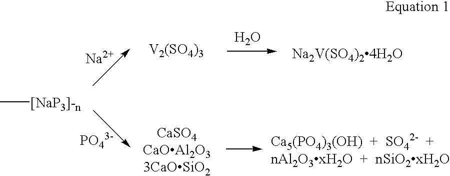

Equation 1 shows that the calcium cations liberated from the boiler ash and the calcium aluminate cement have a strong chemical affinity for the phosphate anions dissociated from the sodium phosphate acid solution, which leads to the formation of calcium phosphate compounds. Further, the sodium cations react favorably with the vanadium sulfate to yield sodium vanadium sulfate compounds. The hydration of these reaction products contributes to the promotion of their crystallization. This develops a dense microstructure in the CBC.

Moreover, we have discovered that heavy metals can be sequesterred and leaching reduced or inhibited altogether by careful selection of bottom ash particle sizes even without utilizing any ASC. In a preferred embodiment, the CBC contains about 55% bottom ash, 40% calcium aluminate, and 5% sodium phosphate. This formulation contains no ASC or calcium silicate cement and achieves vanadium metal sequestering by the use of bottom ash material wherein about 65% of the material has a particle size below abut 75 mm. This CBC material, and that utilizing other bottom ash particle sizes together with ASC oran optional ACS component are useful in soil remediation applications of heavy metal contaminants by mixing the CBC with the soil, in soil backfill systems, in road repair and capping, and various other uses where the potential for leaching of heavy metals to the environment is a concern.

The toughness and ductility of CBC concretes can be further improved through the addition of various fibrous materials. Potential fibrous materials include, for example, E-glass, polypropylene, and carbon fibers. In preparing fiber-reinforced CBC composites, 0.5, 1.0, and 1.5 weight percent of these fibers relative to the CBC was incorporated into CBC concrete slurries consisting of 65.9 weight percent dry CBC, 6.6 weight percent CA, 9.9 weight percent SA, 3.2 weight percent of a 50 weight percent ASC aqueous solution, and 14.4 weight percent water. The CBC slurries were then cast into cylindrical molds for a tensile splitting test and into beam molds for a bending test. The casts were allowed to cure for twenty-four hours at an atmospheric environment of 25° C.

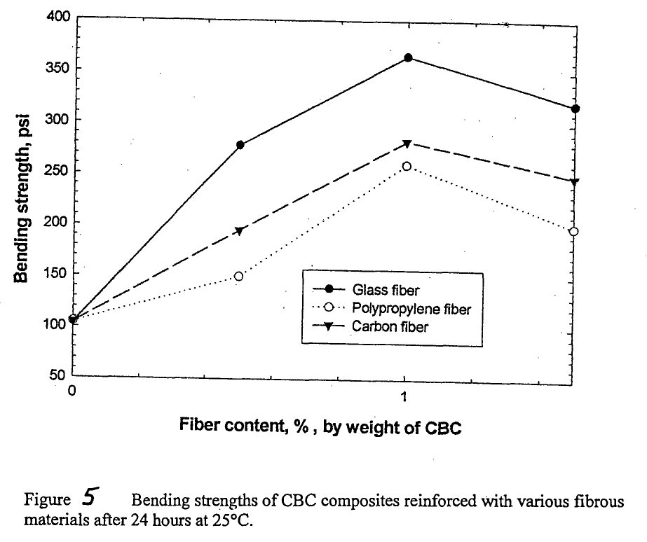

FIG. 5 plots the changes in bending strength as a function of the amount of fiber. As shown, the E-glass fibers exhibited a higher bending strength than the polypropylene and carbon fibers. Further, the highest bending strength was exhibited for all three fibers at one weight percent. The bending strength of about 360 psi for one weight percent E-glass fiber reinforced concrete composites was more than three times greater than that of non-reinforced concrete composites.

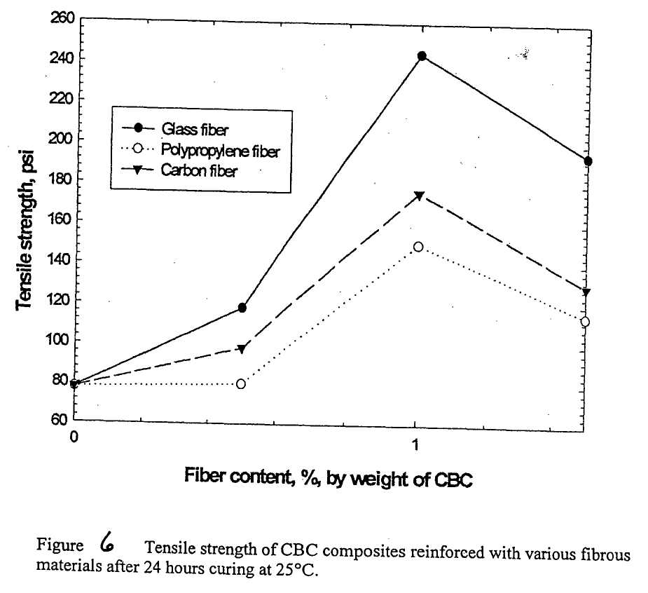

FIG. 6 plots the changes in tensile strength as a function of the amount of fiber. Again, the E-glass fibers exhibited a higher tensile strength than the polypropylene and carbon fibers. Further, the highest tensile strength was exhibited for all three fibers at one weight percent. The tensile strength of about 240 psi for one weight percent E-glass fiber reinforced concrete composites was more than three times greater than that of non-reinforced concrete composites.

It should further be noted that reinforcing conventional portland cement concrete with glass fibers is difficult due to a high susceptibility to alkaline degradation in the portland cement slurry, which has a pH of about 12. However, the pH of the CBC slurries of the present invention is typically much less, such as about 9.2, thus allowing the glass fibers to more easily incorporate into the CBC concrete. A preferred formulation of CBC concrete is about 65.3 weight percent CBC, about 6.5 weight percent CA, about 9.7 weight percent SA, about 3.2 weight percent ASC, about 0.7 weight percent glass fibers, and about 14.6 weight percent water.

An indispensable property for patch repairing materials is that they must be able to adhere to old cement and asphaltic concrete adherends (old materials to which the patch materials will adhere). Inadequate adhesion at the interface between the repairing materials and the adherends can cause a failure of the patched materials due to penetration of water into the intersticial spaces between the old adherends and the patch materials. Thus, additional testing was performed to ascertain the adherence properties of the CBC concrete of the present invention.

Old cement concrete specimens were prepared by mixing 41 weight percent Type I portland cement, 20 weight percent CA, 20 weight percent SA, and 19 weight percent water and then casting into beam molds and curing at an atmospheric environment at 25° C. for twenty-eight days. Then, the casts were cut in half and one of the halves was returned to the mold. The CBC composite slurries were prepared utilizing 65.3 weight percent CBC, 6.5 weight percent CA, 9.7 weight percent SA, 3.2 weight percent ASC, 0.7 weight percent glass fibers, and 14.6 weight percent water.

Then the CBC composite slurry was poured into the empty portion of the mold containing the adherend half and allowed to cure for seven days at 25° C. or at 0° C. Three different conditions, namely dry, wet and icy, were employed to ascertain whether the CBC concrete composites would link appropriately to the cement adherend in all seasons. The strength of the linkage between each CBC concrete composite and a respective adherend was estimated by comparing the values of bond strength computed from the maximum load at the failure of the composite-adherend joint. Control test materials were also created by linking Type I portland cement concrete slurries to the adherend. Also, a visual inspection of the joint failure of the specimens was made after the bending test. The results of that test are provided in Table 10 below.

TABLE 10

| | Surface | Curing | Bond | Adhesion |
|---|---|---|---|---|
| | of concrete | temperature, | strength, | failure |
| Adhesive | adherend | ° C. | psi | mode |
| Composite | Dry | 25 | 26.8 | Cohesive |
| | | | | failure in |
| | | | | adherend |
| Composite | Wet | 25 | 27.0 | Cohesive |
| | | | | failure in |
| | | | | adherend |
| Type I | Dry | 25 | 8.2 | Adhesive |
| | | | | failure at |
| | | | | interfaces |
| Type I | Wet | 25 | 9.0 | Adhesive |
| | | | | failure at |
| | | | | interfaces |
| Composite | Dry | 0 | 18.0 | Mix mode |
| | | | | of cohesive |
| | | | | and adhesive |
| | | | | failures |
| Composite | Icy | 0 | 18.9 | Mix mode |
| | | | | of cohesive |
| | | | | and adhesive |
| | | | | failures |
| Type I | Dry | 0 | 2.9 | Adhesive |
| | | | | failure at |
| | | | | interfaces |
| Type I | Icy | 0 | * | Adhesive |
| | | | | failure at |
| | | | | interfaces |

The bond strengths at the interfaces between the CBC concrete and the adherend (composite) was much greater than the bond strengths between the Type I concrete and the adherend in all the tested conditions. The Type I concrete bonded poorly to the wet and dry adherend and bond strength was too low to be measured for the icy adherend.

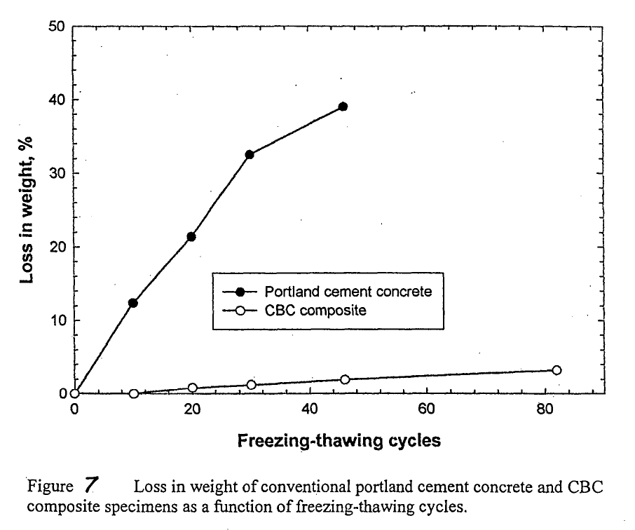

Next, an investigation of the resistance of the CBC composites to rapidly repeated cycles of freezing and thawing was performed. Again, for purpose of comparison ordinary Type I portland cement concrete specimens were used as a control. The seven day cured CBC concrete composite and Type I portland cement concrete specimens were placed in a freezing-thawing chamber. A full freezing and thawing cycle consisted of alternately lowering the temperature from 40 to 0° F. (4.4 to −17.8° C.) and raising it back up to 40° F. within four hours. Then, the loss in weight for the specimens was measured after ten, twenty, thirty, forty-six and eighty-two cycles to determine their durability. FIG. 7 plots the loss of weight for the CBC concrete composites and the Type I portland cement concrete specimens. As is shown in FIG. 7, the Type I portland cement concrete failed after forty-six cycles, exhibiting weight loss on the order of about forty percent. Comparatively, the weight loss of the CBC concrete composites was only about three percent after eighty-two cycles. Thus, CBC concrete composites have a much greater resistance to freezing and thawing than conventional hydraulic Type I portland cement concrete.

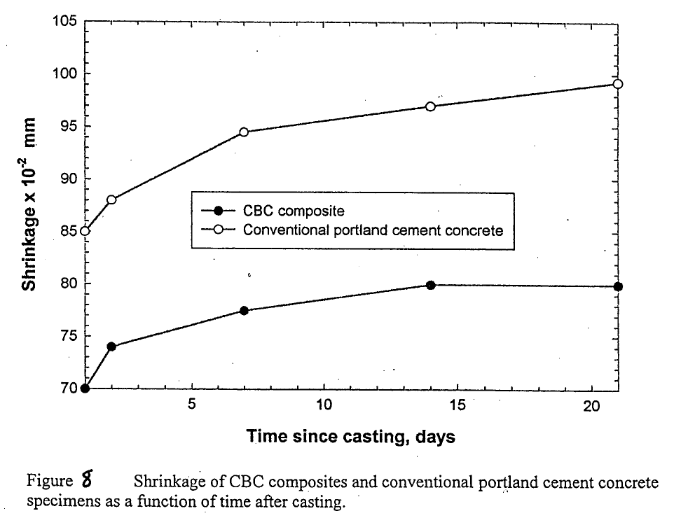

Excessive shrinkage over time can cause failure of the bond structure at the interfacial boundary between a road concrete and the patch material and develops numerous cracks in the road concrete. Such shrinkage allows water to penetrate open spaces in the road concrete or between the road concrete and the patch materials, which can then undermine the remaining patch materials. Testing was performed to determine linear shrinkage of CBC concrete composite specimens as compared to conventional Type I portland cement concrete specimens. FIG. 8 plots the comparison and indicates that CBC concrete composite specimens shrink far less than the conventional Type I portland cement concrete specimens. At twenty-four hours of cure, the shrinkage of the conventional portland cement concrete specimens was 84×10⁻² millimeters and at twenty-one days it was 99×10⁻² millimeters. By contrast, the shrinkage experienced by the CBC composite specimens at twenty-four hours was eighteen percent less than that of the Type I portland cement concrete specimens, or about 70×10⁻² millimeters. The shrinkage of the CBC composite specimens increased up to about fourteen days after cure and leveled off at about 80×10⁻² millimeters.

The water permeability of CBC composites was also tested, specifically by using a Ruska liquid permeameter. Water permeability under a pressure of two atmospheres is determined as

Kₐ=μVL/AP,

where the intrinsic permeability Kₐ is in darcys, V is the rate of flow at the fluid viscosity μ (centipoise), and L and A are thickness (centimeters) and cross-sectional area (centimeters squared) under pressure. Data obtained was correlated directly with the values of porosity and density of the CBC composite specimens through Helium comparison pyconometry. Three specimens were prepared as reference specimens, namely an ordinary Type I portland cement concrete, an ASC-modified CBC specimen, and a non-modified CBC specimen. The reference specimens were used as reference to a glass fiber-reinforced CBC composite containing ASC. The results from a seven day cure of these specimens are shown in Table 11 below.

TABLE 11

| | | | Water |
|---|---|---|---|
| | Density, | | permeability, |
| Cement System | g/cc | Porosity, % | millidarcys |
| Ordinary Type I portland | 2.27 | 38.42 | 0.92 |
| cement | | | |
| CBC | 2.84 | 35.68 | 0.79 |
| ASC-modified CBC | 2.88 | 30.52 | 0.58 |
| Glass fiber-reinforced CBC | 2.28 | 33.72 | 0.59 |
| composite containing ASC | | | |

As can be seen from Table 11, the CBC and ASC-modified CBC are more dense than the ordinary Type I portland cement and have a lower water permeability. The addition of glass fibers to the CBC composite decreases the density, although it is still more dense than the ordinary Type I portland cement. The glass fiber-reinforced CBC composite has a higher porosity than the ASC-modified CBC and a slightly higher water permeability. The results indicate that the incorporation of ASC into the CBC minimizes the number of free voids existing in the CBC bodies. The addition of glass fibers increases the water permeability and porosity, but these values are still thirty-six percent and twelve percent less, respectively, than the water permeability and porosity values for Type I portland cement.

Another important property required for a CBC composite is the ability to protect steel reinforcement bars against corrosion. To test for this characteristic, cut epoxy-coated bars were embedded into composite slurries that were placed in molds and then left for twenty-four hours in an atmospheric environment. Then the hardened cement specimens with the steel bars were removed from the molds and immersed in fifteen weight percent sodium chloride solution at 90° C. Coated steel bars were incorporated into conventional Type I portland cement concrete for comparison. The results showed no traces of corrosion of the steel bars after a three month immersion of both the CBC composites and the ordinary Type I portland cement. However, the composites exhibited far greater adherence to the epoxy-coated steel bar surfaces than the Type I portland cement did.

Next, testing was performed to determine whether the CBC of the present invention can be mixed with soil and used as a backfill underlayment. The soil used contained 7.3 percent water. Table 12 below provides the mix formulation of soil-cement specimens.

TABLE 12

| Specimen | CBC/soil | | | ASC, | Water |
|---|---|---|---|---|---|
| No. | ratio | CBC, wt. % | Soil, wt. % | wt. % | , wt. % |
| 33 | 10/90 | 8.1 | 73.2 | 0.4 | 18.3 |
| 34 | 20/80 | 16.5 | 66.1 | 0.8 | 16.5 |
| 35 | 30/70 | 24.7 | 57.6 | 1.2 | 16.5 |
| 36 | 40/60 | 32.8 | 49.2 | 1.6 | 16.4 |

Backfill underlayment should have a compressive strength in the range of about 40 psi, making it suitable for subsequent manual excavation. Table 13 below provides the results of compressive strength testing for specimens aged for twenty-four hours. As shown, the 20/80 and 30/70 ratios meet this compressive strength criterion.

TABLE 13

| CBC/soil ratio | Compressive strength, psi |
|---|---|
| 10/90 | 8 |
| 20/80 | 28 |
| 30/70 | 52 |
| 40/60 | 165 |

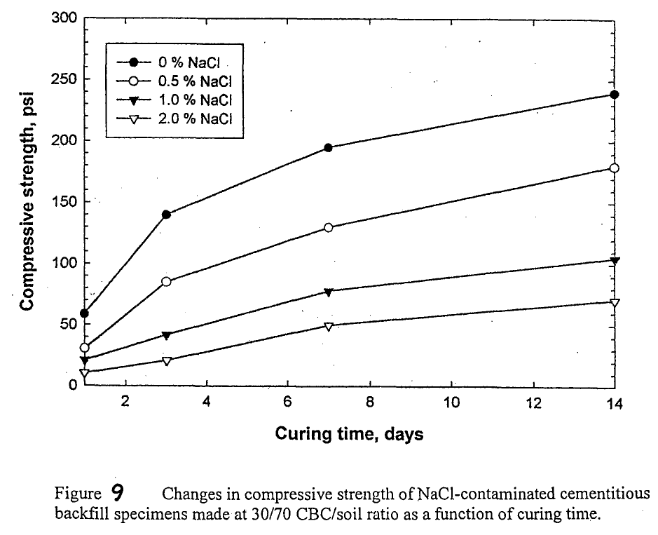

Another concern regarding formulated cementitious backfill material systems is the contamination of the soil by sodium chloride which originates from rock salt used for deicing roadway surfaces during winter. Thus, the effectiveness of sodium chloride contaminated soil in the setting time and the development of strength for backfill soil cements was investigated. Backfill specimens with a CBC/soil ratio of 30/70 were formulated. The soils contained sodium chloride at 0.0, 0.5, 1.0, and 2.0 weight percent. FIG. 9 provides the results of the testing and shows that sodium chloride retards the setting time of cement specimens. The compressive strengths were lower for soils containing greater amounts of sodium chloride than for the soils containing no or smaller amounts of sodium chloride. Nonetheless, the compressive strengths for all the specimens increased with curing time, and even the specimen containing 2.0 weight percent sodium chloride had a compressive strength of about 70 psi after fourteen days of curing.

A method for placing cementitious backfill underlayment will now be described. First, excavated soil which may contain moisture is mixed directly with an appropriate amount of dry packed CBC in a conventional concrete mixer or with hand mixing tools. Second, the well-mixed backfill material is placed in a pit and the surfaces are then tamped to create a densified underlayment structure. Finally, sufficient water is sprayed over the underlayment's surface to allow it to permeate through the densified underlayment structure. When the water comes in contact with the CBC grains, the acid-base reaction of cement is initiated, thereby binding the soil particles into a cohesive mass, leading to the development of a compressive strength of at least about forty psi.

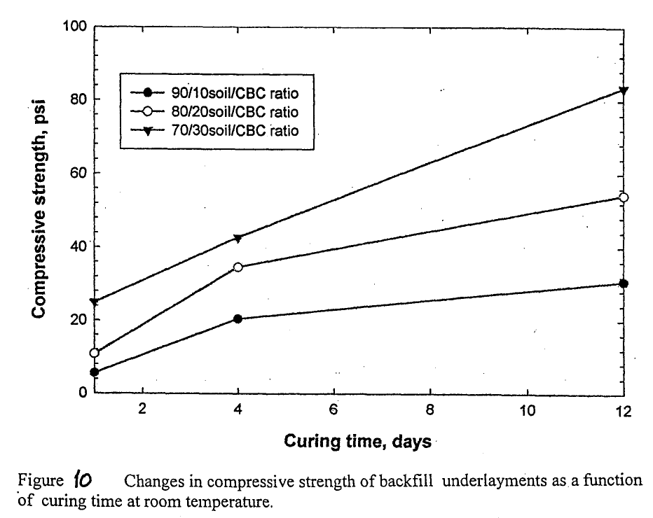

To validate the above described methodology, a 4.7 percent moisture-containing soil was mixed directly with a CBC slurry, and this mixture was placed in a cylindrical mold up to the cylinder's surface. A tamping tool was applied to the surface of the mixture and tamping was performed until there was no depression of the material. Under burden, the sinking depth was about 1.8 inches. Then, 0.4 pounds of water was poured into the space created by depressing the material. The volume fraction of the compacted material to water was 2.7 to 1.0. Most of the water permeated within an hour of pouring. Three mixing formulations were used in this experiment, namely wet soil/CBC ratios of 90/10, 80/20, and 70/30. FIG. 10 displays the changes in compressive strength of the specimens as a function of curing times at room temperature. The results indicate that specimens made with 80/20 and 70/30 ratios provided compressive strength greater than forty psi.

Further testing was performed to ascertain whether CBC composites according to the invention could be utilized to form very lightweight CBC concrete. In this testing, commercial ceramic microspheres called Extendospheres, manufactured by PQ Corporation, were incorporated in the dry CBC concrete specimens instead of sand and aggregate. Extendospheres typically have a density of 0.67 g/cc. The formulations of lightweight CBC concrete slurries are shown in Table 14 below, whereas Table 15 below provides results of dry bulk density and compressive strength testing for three day cured lightweight CBC concrete specimens.

TABLE 14

| Specimen No. | CBC, wt. % | Microsphere, wt. % | Water, wt. % |
|---|---|---|---|
| L-1 | 81.1 | 0.0 | 18.9 |
| L-2 | 59.3 | 19.8 | 20.9 |
| L-3 | 47.6 | 28.5 | 23.9 |
| L-4 | 34.6 | 34.6 | 30.8 |
| L-5 | 23.8 | 39.7 | 36.5 |
| L-6 | 18.2 | 54.5 | 27.3 |

TABLE 15

| Specimen No. | Dry density, g/cc | Compressive strength, psi |
|---|---|---|
| L-1 | 1.87 | 2100 |
| L-2 | 1.33 | 613 |
| L-3 | 1.15 | 158 |
| L-4 | 0.96 | 37 |
| L-5 | 0.78 | 4 |
| L-6 | 0.70 | too weak to be measured |

Next, a method of preparing dry packed CBC concrete composite mixture will be described. The formulation of all the ingredients is provided in Table 16 below.

TABLE 16

Other ingredients, wt. %

| Ingredients of CBC, wt. % | | | | | | Glass | | |
|---|---|---|---|---|---|---|---|---|
| BA | CAC | Type I | NaP | CA | SA | fiber | ASC | Water |
| 36.0 | 18.9 | 4.6 | 5.9 | 6.5 | 9.7 | 0.7 | 3.2 | 14.6 |

Based upon the formulations in Table 16, the amount of materials required to fill a two feet (width) by eight feet (length) by six inch (depth) pit was determined to be 394 pounds of BA (crushed to an average particle size of 200 mesh), 207 pounds of CAC, 49 pounds of Type I portland cement, 65 pounds of sodium phosphate, 35 pounds of acrylic-styrene copolymer, 8 pounds of glass fiber, 71 pounds of coarse aggregate, 106 pounds of sand, and 160 pounds of water.

All of the components except for the acrylic-styrene copolymer, the glass fiber, and the water were blended and packaged together for shipping to a field demonstration site. The remaining components were added to the dry packed composite in the field. To ensure thorough mixing of the components, forty pounds of water was first poured into a rotary shear concrete mixer and rotated for about ten seconds to wet its entire interior. Then, two pounds of glass fiber was added to the continuously rotating wet mixer, followed by 223 pounds of the dry packaged composite. Finally, 8.7 pounds of the acrylic-styrene copolymer was blended into the slurry and mixed for about five minutes.

The mixture was discharged from the mixer into a test pit, and was of such a consistency that it was able to self-level. The above-described process was continued until 1094 pounds of the composite slurry had been placed in the pit. The surface of the slurry was then smoothed with a trowel to improve the surface texture. After about 90 minutes, the composite slurry had sufficient strength to be stepped on.

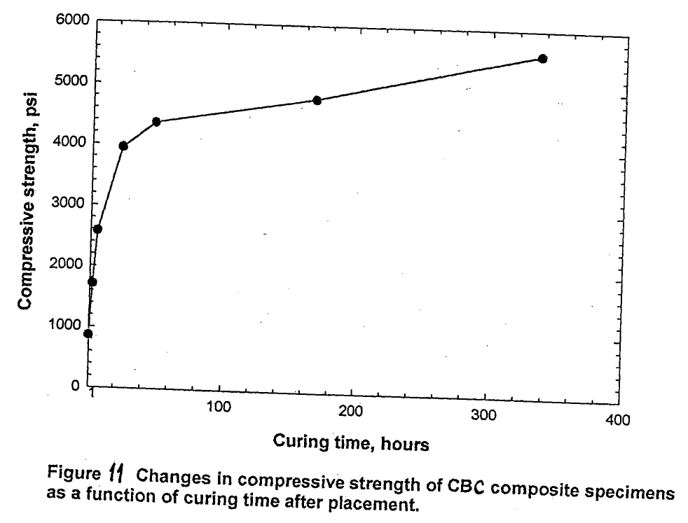

The mixture was concurrently placed in molds to monitor the compressive strength change over time for the specimens, and the results are displayed in FIG. 11. After one hour of cure in an atmospheric environment at 35° F., the specimens exhibited a compressive strength of 860 psi. It has been determined that a compressive strength of around 500 psi for a concrete patch will sustain vehicular traffic, and thus the results indicate that vehicular traffic can resume shortly after pouring of the concrete patch, such as within about one hour. The compressive strength of the specimens increased to 5600 psi after fourteen days of curing. The compressive strength mainly develops within the first two days of curing, with a gradual increase over time thereafter.

While the invention has been described in detail in connection with exemplary embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Accordingly, the invention is not to be seen as limited by the foregoing description, but is only limited by the scope of the appended claims.

What is claimed as new and desired to be protected by Letters Patent of the United States is:

1. A dry cement mixture, comprising:
a calcium aluminate component;
optionally a calcium silicate component;
a sodium phosphate compound; and
boiler ash.

2. The cement mixture of claim 1, comprising:
about forty weight percent of said calcium aluminate component;
about five weight percent of said sodium phosphate compound; and
about fifty-five weight percent of said boiler ash.

3. The cement mixture of claim 1, further comprising a polymeric compound capable of reducing leaching one or more of heavy metals from the cement mixture in use.

4. The cement mixture of claim 3, wherein said polymeric compound comprises an acrylic-styrene copolymer.

5. The cement mixture of claim 4, wherein the ratio of said acrylic-styrene copolymer to the cement mixture is between about 0.05 to one and about 0.15 to one.

6. The cement mixture of claim 1, wherein said sodium phosphate compound is polybasic sodium phosphate.

7. The cement mixture of claim 1, further comprising fibrous materials.

8. The cement mixture of claim 7, wherein said fibrous materials comprise at least one material selected from the group consisting of E-glass fibers, carbon fibers, and polypropylene.

9. The cement mixture of claim 1, wherein said boiler ash has a particle size such that about 65% is less than 75 mm diameter.

10. The cement mixture of claim 9, comprising about 55% boiler ash, about 40% calcium aluminate component, and about 5% sodium phosphate compound.

11. A dry concrete mixture, comprising:
active ingredients, including:
a calcium aluminate component;
optionally calcium silicate component;
a sodium phosphate compound; and
boiler ash; and
inactive aggregates.

12. The concrete mixture of claim 11, wherein the ratio of said active ingredients to said inactive aggregates is between about 60:40 and about 100:0.

13. The concrete mixture of claim 11, further comprising a polymeric compound capable of reducing leaching out of one or more heavy metals from said active ingredients in use.

14. The concrete mixture of claim 13, wherein said polymeric compound comprises an acrylic-styrene copolymer.

15. The concrete mixture of claim 11, further comprising fibrous materials.

16. The concrete mixture of claim 15, wherein said fibrous materials comprise at least one material selected from the group consisting of E-glass fibers, carbon fibers, and polypropylene.

17. The concrete mixture of claim 11, wherein said boiler ash has a particle size such that about 65% is less than 75 mm diameter.

18. The concrete mixture of claim 17, comprising about 55% boiler ash, about 40% calcium aluminate component, and about 5% sodium phosphate compound.

19. A lightweight dry concrete mixture, comprising:
active ingredients, including:
a calcium aluminate component;
optionally a calcium silicate component;
a sodium phosphate compound; and
boiler ash; and
inactive aggregates, including ceramic microspheres.

20. The lightweight dry concrete mixture of claim 19, wherein the ratio of said active ingredients to said inactive aggregates is between about 60:40 and about 75:25.

21. An all weather road capping material, comprising:
a chemically-bonded cement material, including:
a calcium aluminate component;
a calcium silicate component;
a sodium phosphate compound; and
boiler ash;
an aggregate material; and
water;
wherein said sodium phosphate compound reacts with said boiler ash to form one or more calcium phosphate compounds in said chemically bonded cement material.

22. The all weather road capping material of claim 21, wherein the percentage of said chemically-bonded cement material is between about sixty and about eighty percent.

23. The all weather road capping material of claim 21, wherein the ratio of said chemically-bonded cement material to said aggregate materials is about 80:20.

24. The all weather road capping material of claim 21, further comprising coarse aggregates at less than about thirteen percent.

25. The all weather road capping material of claim 21, further comprising sand aggregates at less than about thirteen percent.

26. The all weather road capping material of claim 21, further comprising a ratio of coarse aggregates to sand aggregates at about 40:60.

27. The all weather road capping material of claim 21, further comprising a polymeric compound capable of reducing leaching out of one or more heavy metals from said active ingredients in use.

28. The all weather road capping material of claim 27, wherein said polymeric compound comprises an acrylic-styrene copolymer.

29. The all weather road capping material of claim 21, further comprising fibrous materials.

30. The all weather road capping material of claim 29, wherein said fibrous materials comprise at least one material selected from the group consisting of E-glass fibers, carbon fibers, and polypropylene.

31. The all weather road copping material of claim 21, wherein said boiler ash has a particle size such that about 65% is less than 75 mm diameter.

32. The all weather road copping material of claim 31, comprising about 55% boiler ash, about 40% calcium aluminate component, and about 5% sodium phosphate compound.

33. A cementitious soil material, comprising:
a chemically-bonded cement material, including:
a calcium aluminate component;
optionally a calcium silicate component;
a sodium phosphate compound; and
boiler ash which chemically reacts with said sodium phosphate compound;
a polymeric compound capable of inhibiting leaching out of one or more heavy metals from said chemically-bonded cement material in use;
soil; and
water.

34. The cementitious soil material of claim 33, wherein the ratio of said chemically-bonded cement material to said soil is between about 10:90 and about 40:60.

35. The cementituious soil material of claim 33, wherein said boiler ash has a particle size such that about 65% is less than 75 mm diameter.

36. The cementituous soil material of claim 35, comprising about 55% boiler ash, about 40% calcium aluminate component, and about 5% sodium phosphate compound.

37. A method of forming a road capping material, comprising:
providing a chemically-bonded cement material that includes calcium aluminate cement, optionally calcium silicate cement, a sodium phosphate compound, and boiler ash which chemically reacts with said sodium phosphate compound;
providing coarse aggregates and sand aggregates;
providing water;
mixing said chemically-bonded cement material, said coarse aggregates, said sand aggregates and said water; and
allowing the mixture to cure.

38. The method of claim 37, further comprising mixing in a polymeric compound capable of reducing leaching out of one or more heavy metals from said chemically-bonded cement material in use.

39. The method of claim 38, further comprising mixing in a fibrous material.
